(19) United States
(12) Patent Application Publication
(10) Pub. No.: US 2025/0182940 A1
(43) Pub. Date: Jun. 5, 2025

(54) TEMPERATURE AND SALINITY TOLERANT MAGNETIC NANOFLUID, PREPARATION METHOD AND USE THEREOF

(71) Applicant: CHINA UNIVERSITY OF PETROLEUM (EAST CHINA), Qingdao (CN)

(72) Inventors: Mingwei ZHAO, Qingdao (CN); Caili DAI, Qingdao (CN); Zhenfeng MA, Qingdao (CN); Yining WU, Qingdao (CN); Lin LI, Qingdao (CN); Zhongzheng XU, Qingdao (CN); Mingwei GAO, Qingdao (CN)

(21) Appl. No.: 18/600,138

(22) Filed: Mar. 8, 2024

(30) Foreign Application Priority Data
Dec. 1, 2023 (CN) 2023116404930

(51) Int. Cl. H01F 1/44

(52) U.S. Cl. CPC H01F 1/445

(57) ABSTRACT

The present invention belongs to the technical field of functional nanomaterials and petrochemicals, and proposes a temperature and salinity tolerant magnetic nanofluid, preparation method and use thereof, wherein the nanofluid comprises: magnetic core-shell structured nanoparticles Fe₃O₄@TiO₂, with a content of 0.01-0.2 wt %, and water. The magnetic nanofluid is temperature and salinity resistant, and the magnetic core-shell structured nanoparticles Fe₃O₄@TiO₂ are characterized in having small particle sizes and uniform dispersion, and are recyclable and reusable, and the recycling rate by using magnet after imbibition displacement experiments is as high as 96%, and the present invention provides an efficient solution for the huge problem in high efficiency development of ultra-low permeability reservoirs.

### TECHNICAL FIELD

The present invention relates to the technical field of functional nanomaterials and petrochemicals and relates to a temperature and salinity tolerant magnetic naofluid, preparation method and use thereof.

### BACKGROUND TECHNOLOGY

With the constant development of the petroleum industry and continuous deepening of mining activities, the rate occupied by ultra-low permeability reservoirs is gradually increasing, and high efficiency development of the ultra-low permeability reservoirs becomes a critical point in the petroleum industry in China. Therefore, it is a problem urgently demanding a solution as to how to improve efficiently the crude oil recovery rate of the ultra-low permeability reservoirs. Currently water flooding and hydraulic fracturing are primary development methods of the ultra-low permeability reservoirs, however, most of the crude oil occurs in nano pores and fine cracks, the connectivity of reservoir pores is poor, flow of fluids therein is not good, and by common chemical flooding good exploitation effects cannot be achieved. With the gradual development of the nanotechnology, application of nanofluids in the petroleum industry becomes wider and wider. Nanofluids have small particle sizes, good mobility, and can reach the pores and micro cracks in the ultra-low permeability reservoirs and form wedge-shaped films in regions where the oil contacts the rocks, with such structures, forward thrust forces are generated, which will in turn enhance spread of the nanofluids, in conjunction with the auxiliary role played by the system in reducing capillary pressure, wettability alteration and relative permeability hysteresis, the oil can be separated from the rock surfaces so as to increase the recovery rate.

CN114774096A disclosed temperature and salinity tolerant nano imbibition displacement agent for low permeability reservoir oil flooding, preparation method and use thereof, wherein the nano imbibition displacement agent comprises primarily a nano surfactant, a nonionic surfactant, a zwitterion surfactant and alcohols, and is characterized in having good temperature and salinity resistance, involving simple preparation processes and low expenses, however, the particle sizes of the nanomaterials are less than 200 nm, which is not appropriate for use in oil exploitation of ultra-low permeability reservoirs in micro-nano pores. CN113292981A disclosed a temperature and salinity resistant heterogeneous nano composite oil displacement system, preparation method and use thereof, wherein the composite oil displacement system has a high viscosity and viscoelasticity, and can act in low permeability reservoirs, however, this requires high cost, which makes it not suitable for wide application. Therefore, it is of high significance to develop small size low cost nanofluids in order to carry out imbibition displacement highly efficiently.

### SUMMARY OF INVENTION

In order to solve the problem existing in the prior art, the present invention aims to provide a temperature and salinity tolerant magnetic nanofluid, preparation method and use thereof. The magnetic nanofluid can tolerate high temperature and high salinity, wherein magnetic core-shell structured nanoparticles Fe₃O₄@TiO₂ are characterized in being of small particle sizes and stable dispersion, and being recyclable and reusable, and after imbibition oil displacement experiments, the recycling rate by using magnet is as high as 96%, which has reduced substantially the usage cost.

To realize the foregoing purpose, the technical solutions of the present invention are as follows:

The present invention first of all provides a temperature and salinity tolerant magnetic nanofluid, comprising: magnetic core-shell structured nanoparticles Fe₃O₄@TiO₂, with a content of 0.01-0.2 wt %, and water.

As the temperature and salinity tolerant nanofluid is subjected to dilution upon entering strata, preferably, the content of the magnetic core-shell structured nanoparticles Fe₃O₄@TiO₂ is 0.05-0.2 wt %, and most preferably, 0.1 wt %.

Further, a preparation method of the magnetic core-shell structured nanoparticles Fe₃O₄@TiO₂ comprising:
(1) dissolving nano Fe₃O₄ in ethanol, giving ultrasonic treatment until even dispersion, thereafter, adding slowly tetrabutyl titanate and ammonia solution, mechanical stirring for 5 h in ambient temperature; and
(2) placing reaction products at 25° C. for 20 h, separating by using magnet, washing by using ultrapure water, vacuum drying at 55° C. and obtaining the magnetic core-shell structured nanoparticles Fe₃O₄@TiO₂.

The magnetic core-shell structured nanoparticles Fe₃O₄@TiO₂ obtained in the present invention as per the foregoing preparation method have particle sizes less than 20 nm.

Further, the water in the temperature and salinity tolerant nanofluid comprises water containing K⁺, Na⁺, Mg²⁺, Ca²⁺ and Cl⁻, wherein a total concentration of K⁺ and Na⁺ does not exceed 40000 mg/L, a total concentration of Ca²⁺ and Mg²⁺ does not exceed 5000 mg/L, and a salinity of the water does not go beyond 90000 mg/L.

Preferably, the water in the temperature and salinity tolerant nanofluid comprises water containing K⁺, Na⁺, Mg²⁺, Ca²⁺ and Cl⁻, wherein a total concentration of K⁺ and Na⁺ is 1000-40000 mg/L, a total concentration of Ca²⁺ and Mg²⁺, and a total salinity of the water is 2000-90000 mg/L, and when the salinity of the water goes beyond this range, aggregations in the magnetic nanofluid will increase.

Further, the present invention proposes a preparation method of the foregoing temperature and salinity tolerant magnetic nanofluid, wherein the preparation method comprises:
(1) adding the magnetic core-shell structured nanoparticles Fe₃O₄@TiO₂ to water to be mother solution; and
(2) during use, adding water to dilute the mother solution when stirring, and obtaining the temperature and salinity magnetic nanofluid with a required concentration.

Further, the present invention further provides use of the temperature and salinity tolerant magnetic nanofluid in imbibition displacement of ultra-low permeability reservoirs.

The temperature and salinity tolerant magnetic nanofluid provided in the present invention is especially suitable for use in ultra-low permeability reservoirs with temperature at 20-120° C., and salinity at 0-90000 mg/L.

Compared with the prior art, the beneficial effects of the present invention are:
(1) The magnetic core-shell structured nanoparticles Fe₃O₄@TiO₂ provided in the present invention is characterized in having very small sizes, wherein the particle diameters are lower than 20 nm, which is adaptive to the sizes of the pore throats of ultra-low permeability reservoirs, and the nanoparticles can easily enter the micro-nano pore throats with little damage on the pore throats.
(2) The magnetic nanofluid in the present invention is environment friendly, capable of self-dispersion, and it is easy to prepare the magnetic nanofluid.
(3) The magnetic nanofluid in the present invention is temperature and salinity tolerant, has good stability, and can satisfy requirements for use in strata conditions of temperature 20-120° C. and salinity 0-90000 mg/L.
(4) The magnetic core-shell structured nanoparticles Fe₃O₄@TiO₂ is recyclable and can be used repeatedly, and after imbibition displacement experiment, the recycling rate by using magnet is as high as 96%.
(5) In the present invention, in view of the technical problems that development rate of crude oil in pores of matrix of ultra-low permeability reservoirs is low and the cost for using nanofluids is high, a temperature and salinity tolerant magnetic nanofluid, preparation method and use thereof is inventively proposed, wherein the magnetic core-shell structured nanoparticles Fe₃O₄@TiO₂ are characterized in being of small diameter and even dispersion, and being recyclable and reusable, after imbibition displacement experiments, the recycling rate by using magnet is as high as 96%, and an efficient solution for the huge problem in ultra-low permeability reservoirs high efficient exploitation is provided.

### BRIEF DESCRIPTION OF DRAWINGS

FIG. 1 is an XPS spectrum diagram of magnetic core-shell structured nanoparticles Fe₃O₄@TiO₂;

FIG. 2 is an infrared spectrum diagram of the magnetic core-shell structured nanoparticles Fe₃O₄@TiO₂ and Fe₃O₄;

FIG. 3 is a TEM diagram showing the magnetic core-shell structured nanoparticles Fe₃O₄@TiO₂;

FIG. 4 is a DLS diagram showing the magnetic core-shell structured nanoparticles Fe₃O₄@TiO₂ and Fe₃O₄;

FIG. 5 is a VSM diagram showing the magnetic core-shell structured nanoparticles Fe₃O₄@TiO₂ and Fe₃O₄;

FIG. 6 shows imbibition displacement experiment results of the magnetic nanofluid, SiO₂ nanofluid commercially available and simulated formation water; and

FIG. 7 shows recycling experiment results by using magnet of the magnetic core-shell structured nanoparticles Fe₃O₄@TiO₂.

### EMBODIMENTS

In order to help understand the purpose, features and advantages of the present invention more clearly, hereinafter a further description will be given to the technical solutions of the present invention. It shall be understood that, without conflict, embodiments of the present invention and features in the embodiments of the present invention can be combined with each other.

In the following description, a lot of details have been set forth to make it convenient to understand the present invention, however, the present invention can be implemented in other methods different from those given herein; apparently, the embodiments in the present description are only some embodiments of the present invention, rather than all.

Hereinafter, the preferred embodiments of the present invention have been described in detail. It shall be understood that, the following embodiments are given for the sake of explanation rather than limiting the protection scope of the present invention. Without departing from the spirit and essence of the present invention, those skilled in the art can make a variety of modifications and alternations to the present invention.

The experiment methods described in the following embodiments are conventional methods unless indicated otherwise.

Embodiment 1: temperature and salinity tolerant magnetic nanofluid for imbibition displacement of ultra-low permeability reservoirs

In the present embodiment, a temperature and salinity tolerant nanofluid for imbibition displacement of ultra-low permeability reservoirs is proposed, wherein the nanofluid comprises magnetic core-shell structured nanoparticles Fe₃O₄@TiO₂, with a content of 0.05-0.2 wt %, the balance being water.

Wherein preparation of the magnetic core-shell structured nanoparticles Fe₃O₄@TiO₂ comprises:
(1) Dissolving nano Fe₃O₄ 2 g in ethanol 120 g, giving ultrasonic treatment for 30 min until uniform dispersion, adding slowly tetrabutyl titanate 4 g and ammonium solution 3 g, mechanical stirring for 5 h in ambient temperature; and
(2) Placing a reaction product at 25° C. for 20 h, separating by using magnet, washing by using ultrapure water, vacuum drying at 55° C. for 12 h and obtaining the magnetic core-shell structured nanoparticles Fe₃O₄@TiO₂, wherein diameters of the magnetic core-shell structured nanoparticles Fe₃O₄@TiO₂ are less than 20 nm.

The water in the temperature and salinity tolerant magnetic nanofluid comprises water containing K⁺, Na⁺, Mg²⁺, Ca²⁺, and Cl⁻, wherein a total concentration of K⁺ and Na⁺ is 1000-40000 mg/L, a total concentration of Ca²⁺ and Mg²⁺ is 100-5000 mg/L, and a salinity of the water is 2000-90000 mg/L.

Embodiment 2: characterization of the magnetic core-shell structured nanoparticles Fe₃O₄@TiO₂

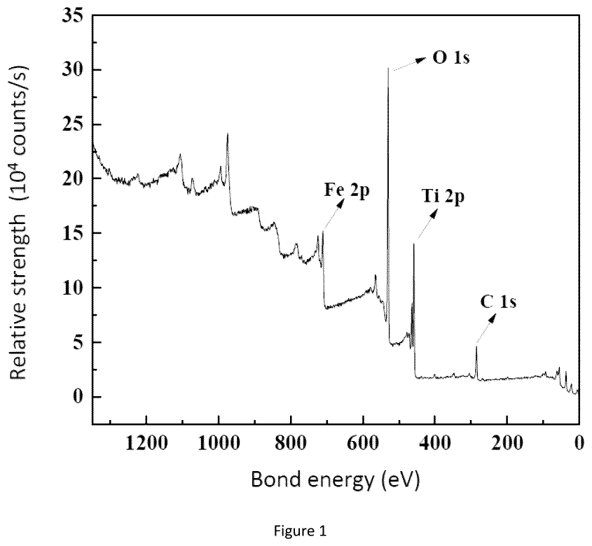

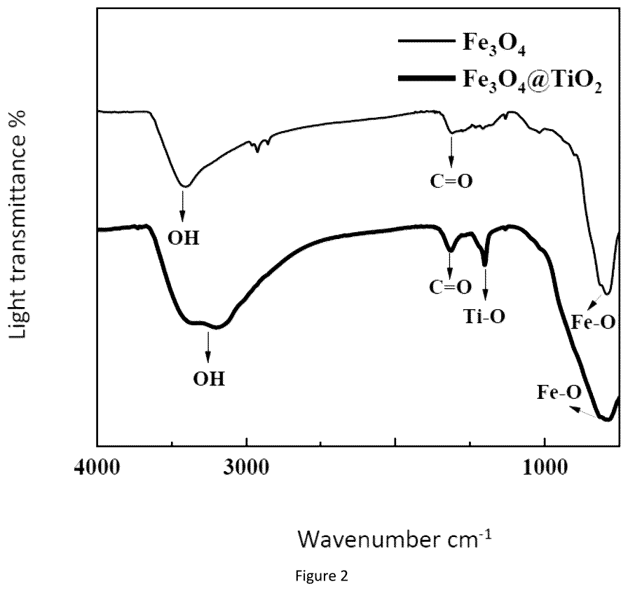

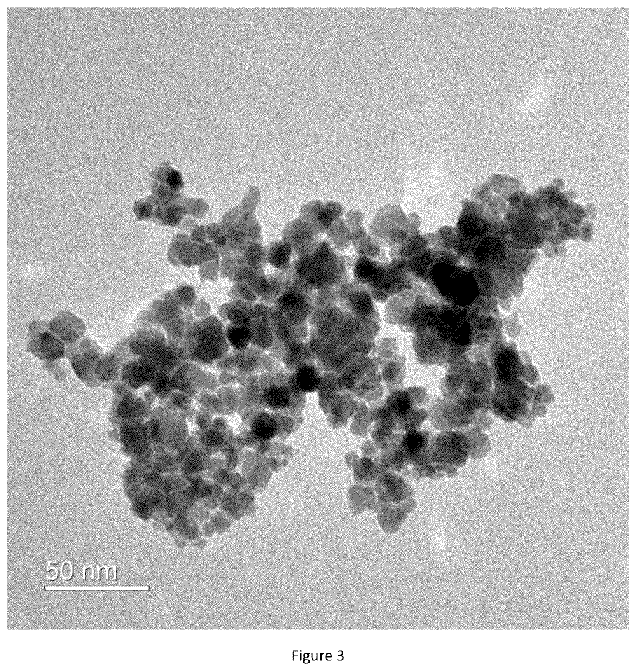

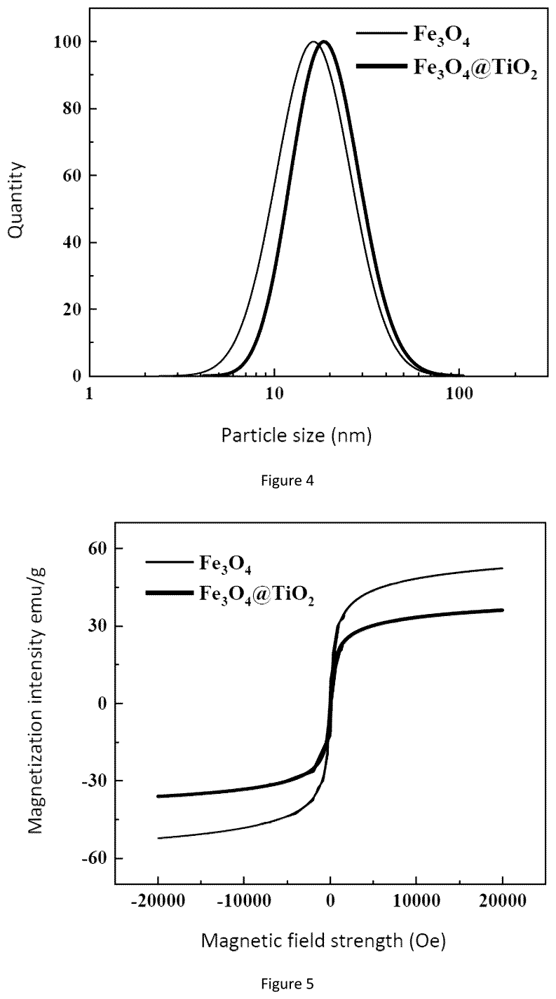

From the XPS of the solid powder test of the magnetic core-shell structured nanoparticle Fe₃O₄@TiO₂, the element composition of the Fe₃O₄@TiO₂ was analyzed, as shown in FIG. 1; from the infrared spectrum of the solid powder test of the magnetic core-shell structured nanoparticle Fe₃O₄@TiO₂ and Fe₃O₄, surface group compositions of the Fe₃O₄@TiO₂ and Fe₃O₄ were analyzed, as shown in FIG. 2; solutions with 0.1 wt % of Fe₃O₄@TiO₂ and Fe₃O₄ were prepared, to test TEM and DLS, to analyze microscopic morphology, shell thickness and diameter distribution of the Fe₃O₄@TiO₂, as shown in FIGS. 3 and 4, wherein the actual diameter sizes were less than 20 nm, the shell thickness is close to 3 nm and the particles are ball-like; solutions with 0.1 wt % of Fe₃O₄@TiO₂ and Fe₃O₄ were prepared, to test VSM, and analyze the magnetization intensity of Fe₃O₄@TiO₂ and Fe₃O₄, as shown in FIG. 5.

Embodiment 3: temperature and salinity tolerance test of the temperature and salinity tolerant magnetic nanofluid

0.1 wt % magnetic core-shell structured nanoparticles Fe₃O₄@TiO₂ fluids with salinity of respectively 0, 10000, 30000, 50000, 70000, 90000, and 110000 mg/L were prepared, after placing in ambient temperature for 7 days, the DLS and Zeta potential was tested to evaluate the salinity resistance performance of the fluids, and the test results were as shown in Table 1, and the salinity resistance ability is as high as 90000 mg/L.

TABLE 1

| Salinity/mg · L⁻¹ | Particle size/nm | Zeta potential/mV |
|---|---|---|
| 0 | 17.7 | −44.6 |
| 10000 | 18.0 | −42.3 |
| 30000 | 17.8 | −41.7 |
| 50000 | 18.4 | −38.9 |
| 70000 | 18.8 | −35.1 |
| 90000 | 19.5 | −30.3 |
| 110000 | 31.4 | −22.7 |

0.1 wt % magnetic core-shell structured nanoparticles Fe₃O₄@TiO₂ fluids, after placing for 7 days at 20, 40, 60, 80, 100, 120, 140° C., the DLS and Zeta potential was tested to evaluate the temperature resistance performance, and the test results were as shown in Table 2, and the temperature resistance ability was as high as 120° C.

TABLE 2

| Temperature/° C. | Particle size/nm | Zeta potential/mV |
|---|---|---|
| 20 | 17.7 | −44.6 |
| 40 | 18.5 | −44.3 |
| 60 | 17.6 | −43.8 |
| 80 | 18.2 | −40.2 |
| 100 | 18.8 | −36.3 |
| 120 | 19.1 | −31.2 |
| 140 | 29.8 | −18.9 |

Embodiment 4: imbibition displacement abilities of the temperature and salinity tolerant magnetic nanofluid

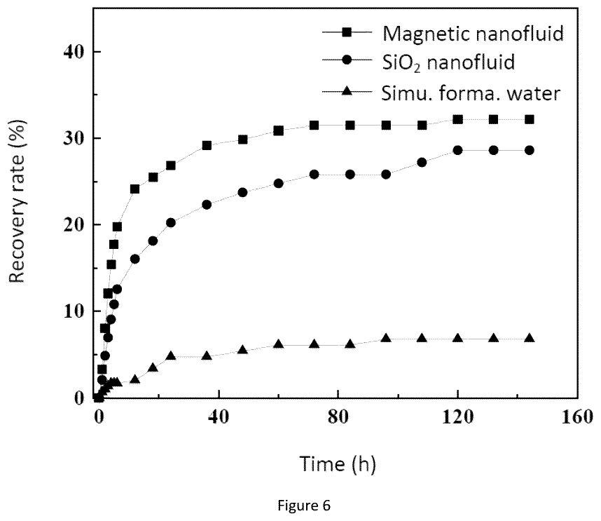

The imbibition displacement ability was evaluated by spontaneous imbibition methods defined in the literature, wherein the experiment steps were: \textcircled{1} measuring the density of the simulated oil; \textcircled{2} cutting rocky outcrops to be sections with length around 3 cm with a core splitter, cleaning and drying, measuring dry weight, diameter, length, porosity and permeability measured by air; \textcircled{3} giving oil saturation treatment by using a high pressure core vacuum saturation device, wiping the simulated oil attached on the surface of the core and measuring the quality of the core after oil saturation; and \textcircled{4} placing an imbibition flask with the core and the temperature and salinity tolerant magnetic nanofluid in a 80° C. constant temperature water bath, reading the scale difference of the oil column in the scaled glass pipe of the imbibition flask in every some time and calculating the imbibition recovery rate. The test results were shown in FIG. 6, and it turned out that, the magnetic nanofluid exhibited good imbibition recovery abilities, and can improve significantly the recovery rate of the ultra-low permeability reservoirs.

Embodiment 5: recyclability of the magnetic core-shell structured nanoparticles Fe₃O₄@TiO₂

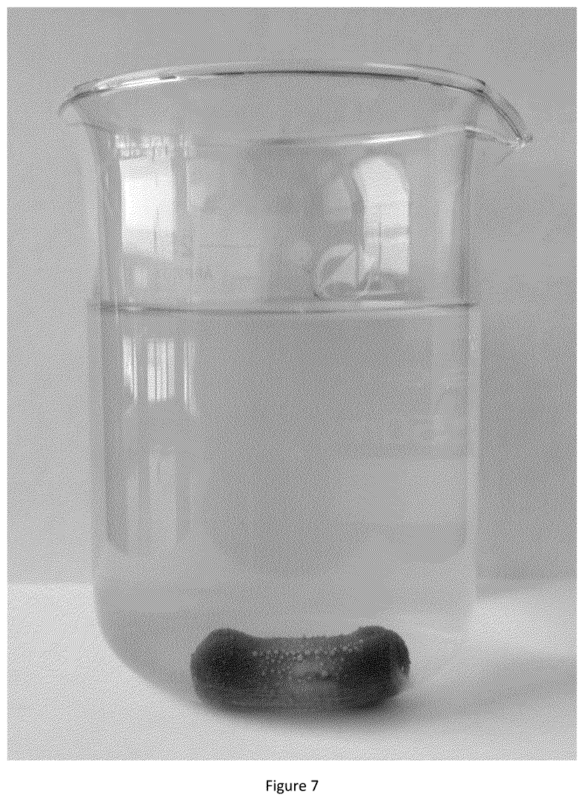

The recyclability was assessed by methods defined in the literature, wherein the experiment steps were: weighing a certain amount of the magnetic core-shell structured nanoparticles Fe₃O₄@TiO₂ for preparing the magnetic nanofluid for imbibition displacement experiments, and after the experiments, adding a piece of magnet, placing for 30 mins and taking the piece of magnet out, drying the nanoparticles attached to a surface of the piece of magnet and calculating the recycling rate. The experiments results were shown in FIG. 7, and it turned out that, after adding the magnet for 30 mins, a large amount of the magnetic core-shell structured nanoparticles Fe₃O₄@TiO₂ were absorbed on the surface of the magnet, and upon calculation, it is found that the recycling rate is 96%.

### Comparative Example 1

With reference to the experiment steps described in the embodiment 4, the recovery rate of the SiO₂ nanofluid commercially available and that of the temperature and salinity tolerant magnetic nanofluid in the present invention were compared.

The maximum recovery rate that the SiO₂ nanofluid commercially available can achieve was 28.6%, and when the content of the magnetic core-shell structured nanoparticle Fe₃O₄@TiO₂ in the temperature and salinity tolerant magnetic nanofluid was 0.1 wt %, the recovery rate was as high as 32.2%.

The reason lies in that, common nano oil flooding agents cannot enter efficiently the ultra-low permeability cores, and the temperature and salinity tolerant nanofluid provided in the present invention is highly adaptive to the pore throats of the ultra-low permeability reservoirs, and can enter easily the micro-nano pore throats and enhance recovery of the ultra-low permeability reservoirs.

The foregoing are some embodiments of the present invention, to have those skilled in the art to understand or implement the present invention. Modifications to the embodiments are obvious to those skilled in the art, the general principles defined in the present invention can be realized in other embodiments without departing from the spirit and scope of the present invention. Therefore, the present invention is not limited to the embodiments listed in the present invention and covers the widest scope that complies with the principles disclosed in the present invention and is consistent with novel features of the present invention.

What is claimed is:

1. A temperature and salinity tolerant magnetic nanofluid, comprising: magnetic core-shell structured nanoparticles Fe₃O₄@TiO₂, with a content of 0.01-0.2 wt %, and water.

2. The temperature and salinity tolerant magnetic nanofluid according to claim 1, wherein the content of the magnetic core-shell structured nanoparticles Fe₃O₄@TiO₂ is 0.1 wt %.

3. The temperature and salinity tolerant magnetic nanofluid according to claim 1, wherein a preparation method of the magnetic core-shell structured nanoparticles Fe₃O₄@TiO₂ comprising:
(1) dissolving nano Fe₃O₄ in ethanol, giving ultrasonic treatment until even dispersion, thereafter, adding slowly tetrabutyl titanate and ammonia solution, mechanical stirring for 5 h in ambient temperature; and
(2) placing reaction products at 25° C. for 20 h, separating by using magnet, washing by using ultrapure water, vacuum drying at 55° C. and obtaining the magnetic core-shell structured nanoparticles Fe₃O₄@TiO₂.

4. The temperature and salinity tolerant magnetic nanofluid according to claim 3, wherein the magnetic core-shell structured nanoparticles Fe₃O₄@TiO₂ have particle sizes less than 20 nm.

5. The temperature and salinity tolerant magnetic nanofluid according to claim 4, wherein the water in the temperature and salinity tolerant nanofluid comprises water containing K⁺, Na⁺, Mg²⁺, Ca²⁺ and Cl⁻, wherein a total concentration of K⁺ and Na⁺ does not exceed 40000 mg/L, a total concentration of Ca²⁺ and Mg²⁺ does not exceed 5000 mg/L, and a salinity of the water does not go beyond 90000 mg/L.

6. The temperature and salinity tolerant magnetic nanofluid according to claim 5, wherein the water in the temperature and salinity tolerant nanofluid comprises water containing K⁺, Na⁺, Mg²⁺, Ca²⁺ and Cl⁻, wherein a total concentration of K⁺ and Na⁺ is 1000-40000 mg/L, a total concentration of Ca²⁺ and Mg²⁺, and a total salinity of the water is 2000-90000 mg/L, and when the salinity of the water goes beyond this range, aggregations in the magnetic nanofluid will increase.

7. A preparation method of the temperature and salinity tolerant magnetic nanofluid according to claim 5, wherein the preparation method comprises:
(1) adding the magnetic core-shell structured nanoparticles Fe₃O₄@TiO₂ to water to be mother solution; and
(2) during use, adding water to dilute the mother solution when stirring, and obtaining the temperature and salinity magnetic nanofluid with a required concentration.

8. Use of the temperature and salinity tolerant magnetic nanofluid according to any of claim 1 in imbibition displacement of ultra-low permeability reservoirs.

9. The use of the temperature and salinity tolerant magnetic nanofluid according to claim 8, wherein strata conditions of the ultra-low permeability reservoirs comprise temperature at 20-120° C.

10. The use of the temperature and salinity tolerant magnetic nanofluid according to claim 8, wherein strata conditions of the ultra-low permeability reservoirs comprise salinity at 0-90000 mg/L.
